(19) United States
(12) Patent Application Publication
(10) Pub. No.: US 2011/0162575 A1
(43) Pub. Date: Jul. 7, 2011

(54) Methods and Apparatus for Seating an Annulus within an Annular Groove

(76) Inventor: David Jahnz, San Diego, CA (US)

(21) Appl. No.: 12/683,766

(22) Filed: Jan. 7, 2010

(51) Int. Cl. G09F 17/00; F16M 13/02

(52) U.S. Cl. 116/173; 248/218.4; 248/219.4

(57) ABSTRACT

Disclosed are methods and apparatus for seating an annulus featuring a fixed inner plan within an annular groove having a rim of greater plan than the inner plan of the annulus.

### CROSS-REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of Invention

The present application is in the field of methods and apparatus for swivelably securing an object to a pole. Most generally, the present application is in the field of methods and apparatus for seating an annulus (ring) within an annular groove having a rim of greater plan than the inner plan of the annulus. In other words, the present application is in the field of fitting an object through a hole that is not big enough to receive it.

2. Background of the Invention

Frequently, it is desirable to secure objects to a pole in a manner whereby the object may swivel around the pole's circumference. For example, it is typically preferable to swivelably attach a flag to a flag pole so that the flag does not become furled about the pole in response to a torquing force since such furling may damage the flag or otherwise diminish the aesthetics of the flag pending manual unfurling. Although not recited with a specific example, other applications exist wherein it is preferable for an object to swivel around a pole in response to a torque. Accordingly, there is a need for apparatus which are capable of swivelably securing an object to a pole.

Previously, objects have been swivelably secured to a pole via apparatus that comprise the following two subassemblies: (1) a ring-shaped rotator; and (2) a collar featuring a recessed annular groove at its periphery for swivelably seating the ring-shaped rotator. In operation, the collar, with the annulus of the ring-shaped rotator circinately seated in the groove between the groove's side-walls, is typically secured to a pole whereby an object affixed to the ring-shaped rotator may freely swivel in response to a torque via the rotator moving along the groove for up to three-hundred and sixty degrees around the pole. For reference, U.S. Pat. Nos. 2,799,240 (issued Jul. 16, 1957), 5,375,555 (issued Dec. 27, 1994) (col. 3: 22-41), 5,495,821 (issued Mar. 5, 1996), 5,522,342 (issued Jun. 4, 1996), and 6,845,730 (issued Jan. 25, 2005) disclose specific embodiments of apparatus of this type.

Typically, in order to seat the ring-shaped rotator within an annular groove for guided rotation therein, the extension of the groove walls must be of a greater plan than the center of the annulus of the ring-shaped rotator. This apparent structural incompatibility has typically resulted in either: (1) the collar being comprised of multiple components to be constructed around the ring-shaped rotator; or (2) the annulus of the ring shaped structure being partially broken (i.e., not a completed ring) or composed of multiple components to be fitted to the collar. For example: U.S. Pat. Nos. 5,495,821 (see U.S. Pat. No. 5,495,821, FIG. 2 and the associated description), 5,522,342 (see U.S. Pat. No. 5,522,342, FIG. 2 and the associated description), and 6,845,730 (see U.S. Pat. No. 6,845,730 and the associated description) disclose an upper and lower component of a collar that are typically sandwiched together within the annulus of a ring-shaped rotator to seat the rotator within an annular groove; and, U.S. Pat. No. 2,799,240 (see U.S. Pat. No. 2,799,240, FIGS. 3 through 5) discloses a broken-ring shaped structure that clips to a collar at an annular groove.

Although capable of swivelably securing an object to a pole, the above mentioned apparatus are not completely satisfactory for their designed purpose. First, among many other drawbacks, complexities and redundancies are associated with the fabrication and assembly of the multi-component collar or ring thereby increasing manufacturing and assembly times and expenses. For instance, U.S. Pat. Nos. 5,495,821, 5,522,342, and 6,845,730 require: (a) the fabrication of multiple collar components; and, (b) the assembly of the multiple collar components around a pole and within the annulus of the ring-shaped rotator. Second, among other drawbacks, multi-component collars or broken ring-shaped rotators lack structural integrity and strength at component-to-component connections, or breaks, whereby the collar and ring are susceptible to malfunction or unplanned component disassociation in response to the forces associated with swivelably securing an object to a pole and guided rotation within a groove. Referring to U.S. Pat. Nos. 5,495,821 (see U.S. Pat. No. 5,495,821, FIG. 2 and the associated description), 5,522,342 (see U.S. Pat. No. 5,522,342, FIG. 2 and the associated description), and 6,845,730 (see U.S. Pat. No. 6,845,730, FIG. 2 and the associated description) the collar component may easily malfunction via breaking into its upper and lower component parts in response to forces obliquely applied to the rotator plane. Referring now to U.S. Pat. No. 2,799,240 (see U.S. Pat. No. 2,799,240, FIGS. 4 and 5 and the associated descriptions), the broken ring-shaped rotator may malfunction by unseating from a groove in response to radial or strong torquing forces in the direction of the break. Accordingly there is still a need for apparatus which are capable of swivelably securing an object to a pole and that avoid the drawbacks mentioned above.

One solution to the above mentioned drawbacks is embodied by U.S. Pat. No. 5,375,555, wherein the collar is designed with a groove having a rim with a plan that is “slightly” larger than the inner plan of the annulus of the rotator. See U.S. Pat. No. 5,375,555, FIG. 4 and col. 3:30-41. Still referring to the U.S. Pat. No. 5,375,555 patent, the collar rim and the annulus of the rotator feature convex surfaces whereby the collar rim may be pushed through the rotator annulus to seat the rotator within the groove. Id. Although the U.S. Pat. No. 5,375,555 embodiment does not feature a collar with multiple components or a broken ring-shaped rotator, the embodiment is not satisfactory for swivelably securing an object to a pole since the rim of the groove has a plan that is only slightly larger than the inner plan of the annulus of the rotator whereby the rotator may be readily and easily unseated from the groove and malfunction whenever the rotator is moved toward the groove rim. Recognizing this weakness in its disclosed embodiment, the U.S. Pat. No. 5,375,555 recommends using two of its apparatuses in mirror when swivelably securing an object to a pole whereby the tendency of the rotator to unseat from the grove is counter balanced. Id., col. 3: 37-58. However, two apparatus for swivelably securing an object to a pole are more expensive than one and certain applications may necessitate the use of a single apparatus. Accordingly there is still a need for apparatus which are capable of swivelably securing an object to a pole in a manner that avoids the drawbacks mentioned above.

Although designed for different purposes than swivelably securing an object to a pole, swivelably seating an annulus within a groove is also known in the art of pipe couplings. Multi-component pipe couplings are known but the multi-component pipe couplings feature drawbacks that are similar to the multi-component collars discussed above. See e.g., U.S. Pat. No. 1,509,562 (issued Sep. 23, 1924). Pipe couplings with annular grooves defined on one side by a rim that tapers from a larger to smaller diameter are also known whereby the tapering rim can be forced through an annulus of a smaller inner plan than the rim, but such couplings feature the drawback of being difficult to unseat the annulus from the groove without a bulky detaching means for stretching the inner plan of the annulus. See e.g., U.S. Pat. No. 5,964,485 (issued Oct. 12, 1999) (FIG. 3, groove 25 and rim 22; FIG. 4, annulus 27 and detaching means 36); see also e.g., U.S. Pat. No. 6,192,886, FIG. 7. Yet still, pipe couplings exist that screw the rim of a groove through the annulus of a smaller plan than the rim, but such a coupling requires the use of more material to fabricate the screw threads than would otherwise be necessary for the groove and rim construction. See e.g., U.S. Pat. No. 4,099,744 (issued Jul. 11, 1978) (FIG. 4, groove 152, rim 155, and annulus 136). Due to the drawbacks mentioned above and differing design goals, the art of swivelable pipe couplings cannot be referenced for a structures or methods that alleviate the design and functional flaws in heretofore known apparatus for swivelably securing an object to a pole. Therefore, there still remains a need for apparatus which are capable of swivelably securing an object to a pole in a manner that avoids the drawbacks mentioned above.

### SUMMARY OF THE INVENTION

It is an object of the present application to disclose apparatus and related methods for swivelably securing an object to a pole in a manner that alleviates the problems associated with apparatus heretofore known for the same purpose. In one non-limiting example, the disclosed apparatus comprises a unitary collar and a unitary ring wherein the ring may be readily seated within, or unseated from, an annular groove on the collar. Further disclosed is a method of assembling the apparatus comprising the steps of either: (1) seating a portion of the ring's annulus within a portion of the groove and levering the collar toward the ring's annulus whereby the ring is annularly seated within the groove; or (2) deforming the collar into a helical configuration, seating a portion of the ring's annulus within a portion of the groove, and rotating the helically configured collar relative to the ring whereby the collar returns to its natural configuration within the annulus of the ring.

It is further an object of the present application to disclose an apparatus for swivelably securing an object to a pole without tedious fabrication or assembly.

It is yet another object of the present application to disclose an apparatus for swivelably securing an object to a pole that is less bulky and requires less material than apparatus known so far.

Yet still, an object of the present application is to disclose an improved apparatus and method for placing an annulus of fixed inner diameter within an annular grove that features sidewalls with a larger plan than the annulus' inner plan.

Other objectives and desires may become apparent to one of skill in the art after reading the below disclosure and viewing the associated figures.

### BRIEF DESCRIPTION OF THE FIGURES

The manner in which these objectives and other desirable characteristics can be obtained is explained in the following description and attached figures in which:

FIG. 1 is a contextual view of a preferable apparatus 1 comprising a unitary collar 100 and ring 200.

FIG. 2A is a top view of the collar 100 of FIG. 1.

FIG. 2B is a bottom view of the collar 100 of FIG. 1.

FIG. 3A is a cross section of the collar of FIG. 2A along the line 3A.

FIG. 3B is a cross section of the collar of FIG. 2A along the line 3B.

FIG. 4A is a top view of a preferable apparatus 1 in an unassembled configuration.

FIG. 4B is a top view of a preferable mode of apparatus 1 assembly.

FIG. 4C is a top view of a preferable apparatus 1 in an assembled configuration.

FIG. 4D is a side view of the apparatus 1 of FIG. 4C.

FIG. 4E is another side view of the apparatus 1 of FIG. 4C.

It is to be noted, however, that the appended figures illustrate only typical embodiments of this invention, and therefore, are not to be considered limiting of its scope, for the invention may admit to other equally effective embodiments that will be appreciated by those reasonably skilled in the relevant arts. Also, figures are not necessarily made to scale.

### DETAILED DESCRIPTION OF PREFERRED EMBODIMENTS

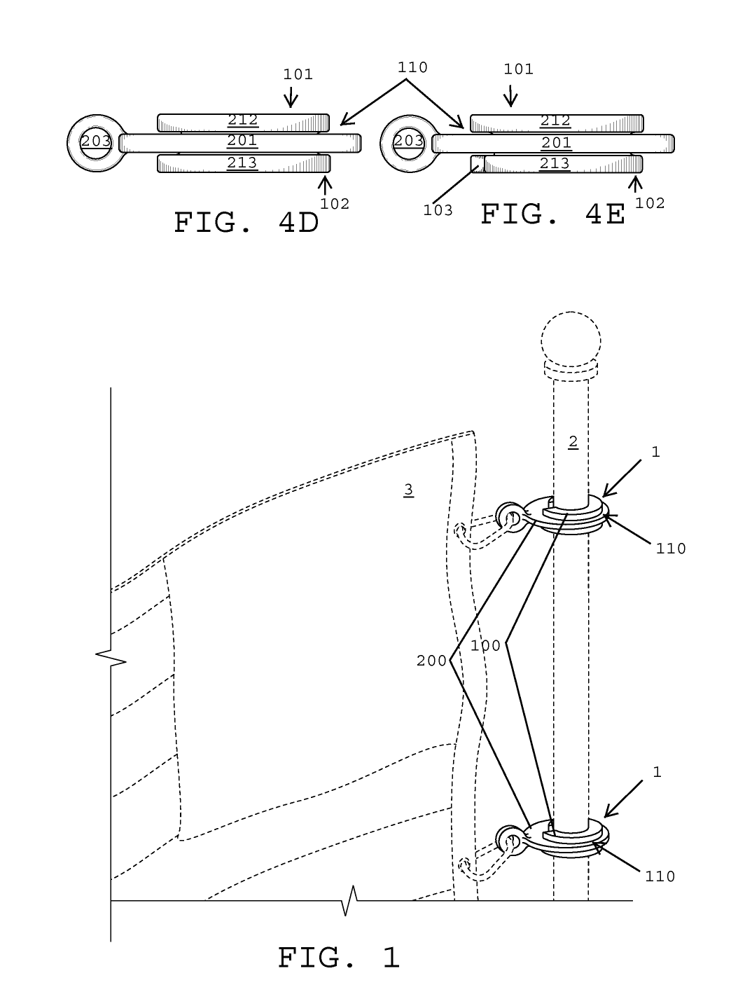

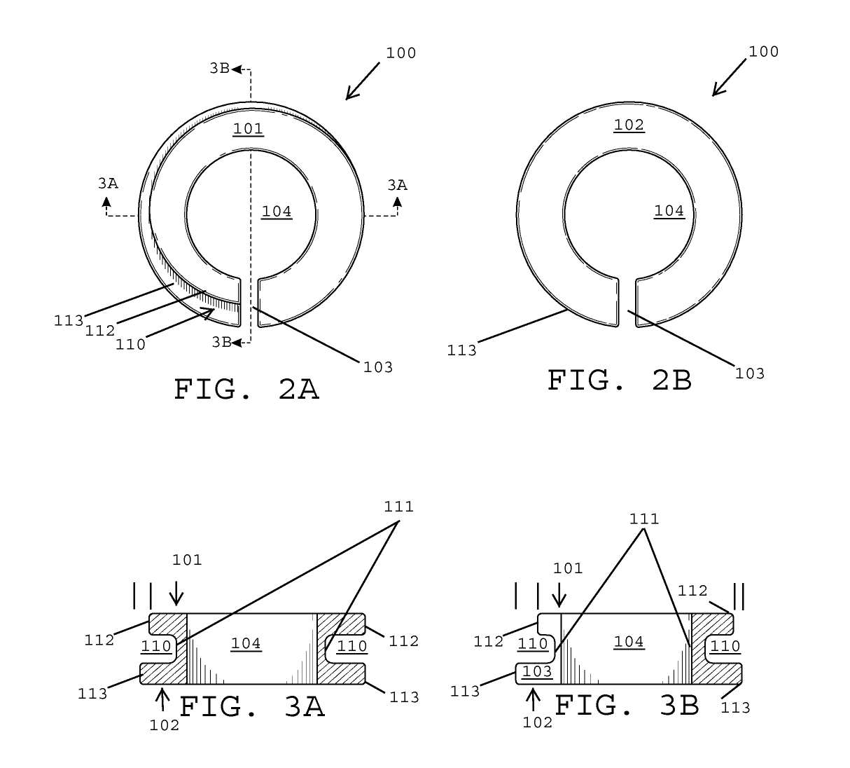

In general, a preferred embodiment of the present application may be an apparatus for swivelably securing an object to a pole. Referring to FIG. 1, the apparatus 1 may comprise a unitary ring 200 annularly seated within a groove 110 on a unitary collar 100 wherein the ring 200 rotates within the groove 110 and relative to the collar 100 in response to a torque. Suitably, the collar 100 is configured to be secured to a pole 2 and the ring 200 is configured to be secured to an object 3 whereby the object 3 may be directed around the pole 2 via the apparatus 1. Preferable assembly of the apparatus 1 is accomplished generally via: introducing a first portion of the collar 100 into the center of the ring's 200 annulus whereby a portion of the ring 200 is seated in the collar's 100 groove 110; and levering the remainder of the collar 100 toward the center of the ring's 200 annulus until the ring 200 is annularly seated within the groove 110. An alternate, but still preferable, assembly method may include the steps of: deforming the collar 100 into a helical configuration; seating a portion of the ring's 200 annulus within a portion of the groove 110; and, rotating the helically configured collar 100 relative to the ring 200 so that the collar 100 returns to its natural configuration within the annulus of the ring 200. The more specific aspects of the preferred apparatus' 1 structure and assembly procedures are best disclosed by reference to FIGS. 2A through 4E.

FIGS. 2A and 2B respectively illustrate the top and bottom view of a preferable embodiment for a unitary collar 100. Referring to FIG. 2A, FIGS. 3A and 3B respectively depict cross sections of the collar 100 along the lines 3A and 3B. Referring now to FIG. 2A through 3B, the unitary collar 100 may feature: a top side 101; a bottom side 102; a deflection accommodator 103; a pole receptacle 104; and an annular groove 110 encircling the pole receptacle 104, the groove 110 preferably being defined by a race 111 (inner most part of the groove 110), an upper wall 112 or rim, and a lower wall 113 or rim. Collectively, FIGS. 2A through 3B illustrate the preferable structural aspects of the collar 100 and its above-mentioned parts. Although disclosed in terms of a “top” and “bottom” side or “lower” and “upper”, the terms “top,” “bottom,” “upper,” or “lower” or any other orientation defining term should in no way be construed as limiting of the possible orientations of the apparatus 1 (i.e., the collar 200 may be positioned sideways, or in reversed vertical orientations even though the specification refers to a “top” and “bottom” side).

Referring now to FIGS. 2A through 3B, the collar 100 composing the preferable embodiment may feature a generally cylindrical tubiform wherein the axially oriented bore or socket may suitably define the pole receptacle 104. Suitably, the pole receptacle 104 receives a pole via insertion of the pole into the socket at the bottom surface 102 whereby the pole may continue through the collar 100 to extend through the top surface 101. Although the plan view of FIGS. 2A and 2B suitably depict a pole receptacle 104 with a circular cross-section for receiving generally cylindrical poles, it is contemplated that the cross-section of the pole receptacle 104 may also feature a cross-section of any other shape to accommodate poles of varying cross-sectional dimensions.

Still referring to FIGS. 2A through 3B, the annular groove 110 may be provided around the outside of the collar's 100 tubiform. Suitably, the groove 110 may define a continuous radial depression in between the top 101 and bottom 102 surfaces on the collar's 100 side surface. The groove 110 may represent an abrupt reduction in the outer diameter of the collar's 100 tubiform at the midsection of the collar 100 so that the upper 112 and lower 113 walls or rims of the groove are formed with the top 101 and bottom 102 surfaces. The race 111 (floor of the groove 110) is preferably defined by the deepest (i.e., most reduced outer diameter relative to the top 101 and bottom 102 surfaces) portion of the groove 110. Suitably, the groove 111 is for annularly seating the ring 200 within the collar 100 in order to swivelably guide an object around a pole.

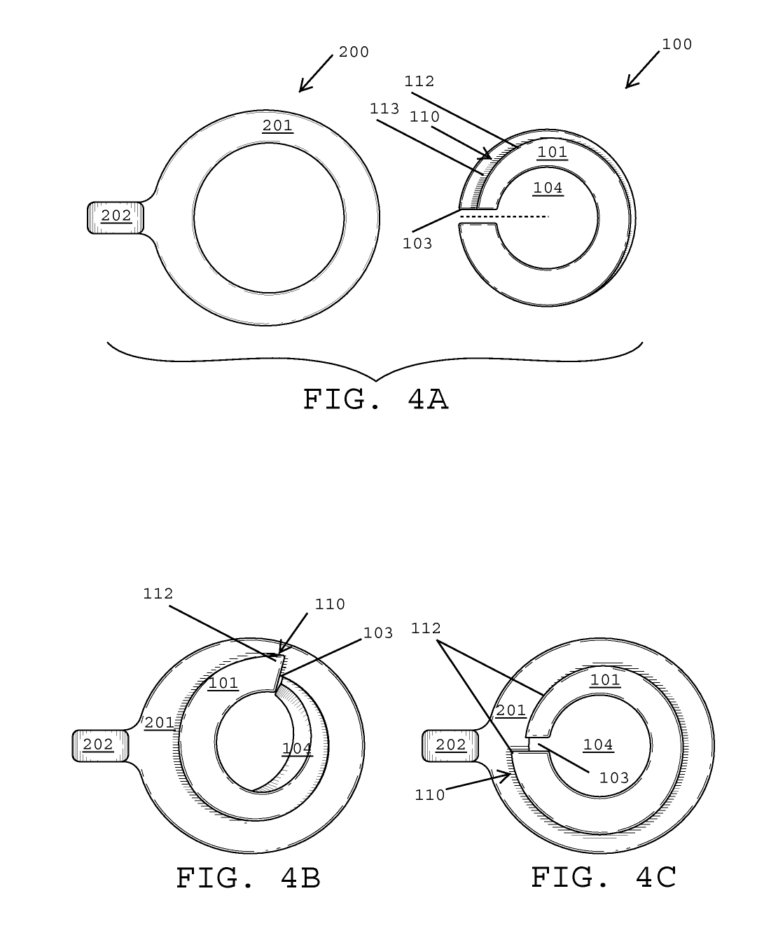

As discussed below, the collar 200 may be placed within a ring 100 (see FIG. 4A) having a hole that is not, without more, big enough to receive the collar 200 via passing one of the upper 112 or lower 113 walls through the ring 100 so that the ring is seated in the groove 110. To this end: (1) the collar preferably features a deflection accommodator 103, as discussed below; and (2) one of the upper 112 or lower 113 walls may suitably feature a spiraling plan (i.e., gradually increasing groove 110 depth with respect to one side of the groove 110 when circumnavigating the race 111), as discussed in detail below and as best seen in FIG. 2A.

Yet still referring to FIGS. 2A through 3B, a radial slot may be provided to the collar's 100 tubiform to create a deflection accommodator 103. The deflection accommodator 103 may suitably permit the mechanical deformation of the collar's 100 structure. For example, the structure of the collar 100 may be deformed via applying a force in opposite directions along the line 3A of FIG. 2A whereby the deflection accommodator 103 slot closes and the practical diameter of the collar's 100 tubiform is correspondingly reduced (e.g., the perimeter of the upper wall's 112 plan is reduced). For another Example, the structure of the collar 100 may be deformed via: applying scissoring forces which are: normal to the top surface 101 at a first side of the line 3A of FIG. 2A; normal to the bottom surface 102 at a second side of the line 3A of FIG. 2A; and, so the structure of the collar 100 twists to produce a scissoring motion across the deflection accommodator 103 slot and provide the collar with a generally helical configuration. Any number of directional forces may be combined so the collar's 100 structure twists and compresses in accordance with the above mentioned examples. In a preferable embodiment, the collar 100 is unitarily formed of a resilient material so that its structure may return to its initial configuration after deformation.

As mentioned above, the collar 100 should preferably be resilient under structural deformation. Accordingly, the collar 100 should preferably be composed of materials resulting in the desired deformation and resiliancy properties, yet with sufficient structural strength to retain a ring 200 within the groove 110 despite substantial torquing or axial forces. Such materials will be readily known to one of skill in the art, and may include, without being limited to: plastics (e.g., Nylon), polymers, PVC, polypropylene, polyethylene; formed metals; woods; ceramics; composites and other synthetic or natural materials whether molded, extruded, stamped or otherwise fabricated.

Still referencing FIGS. 2A through 3B, an important structural feature of the collar 100 alluded to above is the spiraling plan or spiraling outer diameter (or “spiral” or “spiraling wall or rim”) of the upper wall 112 around the collar's 100 tubiform. In simple terms, the groove 110 suitably features a spiraling rim due to a gradually increasing groove 110 depth (with respect to the upper wall 112 or rim) moving along the race 111 from one side of the deflection accommodator 103 slot to the other side (see FIG. 2A for a view of the spiral). Describing the spiraling rim 112 in another way, and referencing FIGS. 2A, 3A, and 3B, the upper wall 112 of the groove 110 features: an outer diameter that is preferably less than the outer diameter of the lower wall 113 at one side of the deflection accommodator 103 slot; an outer diameter that is preferably less than or equal to the outer diameter of the lower wall at the other side of the deflection accommodator 103 slot; and an outer diameter that preferably spirally increases for three-hundred and sixty degrees around the collar's 100 axis with the deflector accommodator 103 slot as the origin. In another preferable embodiment, the outer diameter of the upper wall 112 spirally increases for only two-hundred and seventy degrees from a deflector accommodator 103 slot origin before remaining steadily equal with the outer diameter of the lower wall for the remaining ninety degrees. It is also contemplated that a preferable collar may feature an upper wall with an outer diameter or plan that spirally increases for any number of degrees in a range of about one-hundred and eighty and three-hundred and sixty degrees from a deflector accommodator 103 slot origin before remaining steadily equal with the outer diameter of the lower wall 113 for the remaining degrees.

With yet an additional reference to FIGS. 2A through 3B, a first preferable embodiment of the collar 100 may suitably be dimensioned as follows: the diameter of the pole receptacle 104 socket, 0.800 inch; outer diameter of the lower wall, 1.400 inches; the distance between the top 101 and bottom 102 surfaces, 0.44 inch; the thickness of the upper 112 and lower walls 113, 0.13 inch; the width of the deflection accommodator 103 slot, 0.20 inch; the outer diameter of the groove 110 at the race 111, 1.110 inches; the outer diameter of the upper wall 112 at a first side of the deflector accommodator 103 slot, 1.200 inches; and, the outer diameter of the upper wall 112 at a second side of the deflector accommodator 103 slot, 1.400 inches. In a second preferable embodiment, the collar 100 may alternatively be dimensioned as follows: the diameter of the pole receptacle 104 socket, 0.900 inch; outer diameter of the lower wall, 1.500 inches; the distance between the top 101 and bottom 102 surfaces, 0.44 inch; the thickness of the upper 112 and lower walls 113, 0.13 inch; the width of the deflection accommodator 103 slot, 0.20 inch; the outer diameter of the groove 110 at the race 111, 1.200 inches; the outer diameter of the upper wall 112 at a first side of the deflector accommodator 103 slot, 1.300 inches; and, the outer diameter of the upper wall 112 at a second side of the deflector accommodator 103 slot, 1.500 inches. In yet a third preferable embodiment, the collar 100 may alternatively be dimensioned as follows: the diameter of the pole receptacle 104 socket, 1.100 inches; outer diameter of the lower wall, 1.700 inches; the distance between the top 101 and bottom 102 surfaces, 0.44 inch; the thickness of the upper 112 and lower walls 113, 0.13 inch; the width of the deflection accommodator 103 slot, 0.20 inch; the outer diameter of the groove 110 at the race 111, 1.400 inches; the outer diameter of the upper wall 112 at a first side of the deflector accommodator 103 slot, 1.500 inches; and, the outer diameter of the upper wall 112 at a second side of the deflector accommodator 103 slot, 1.700 inches. Preferably, edges on the collar 100 may be rounded at a 0.05 inch radius of curvature. Suitably, dimension tolerances are: ±0.050 for dimensions identified with one significant digit on the fraction side of the decimal; ±0.010 for dimensions identified with two significant digits on the fraction side of the decimal; and, ±0.005 for dimensions identified with three significant digits on the fraction side of the decimal.

FIG. 4A depicts a top view of an unassembled apparatus 1 with the preferable component parts, namely the ring 200 and the collar 100, positioned side-by-side. FIG. 4B depicts a partially assembled apparatus 1 with the ring 200 partially seated within the groove 110 of the helically deformed collar 100. FIGS. 4C through 4E respectively depict a top, side, and another side view of a preferably assembled apparatus 1. FIGS. 4A through 4E are suitable for illustrating: (1) the structural features of a preferable ring 200; (2) the preferable assembly of the collar 100 and ring 200 into the apparatus 1; and, (3) the functional aspects of the apparatus 1.

FIGS. 4A, 4C, 4D, and 4E, suitably illustrate the structural features of a preferable embodiment for a ring 200. As seen in the drawings, the ring features an annulus 201 and a fastening means 202 for securing an object to the ring 200. As seen in the figures, the annulus 201 may generally resemble a torus with a height (between top and bottom surfaces) and width (between inner and outer diameters). As mentioned above, the ring 200 is adapted for annularly sitting within the groove 110 (see FIGS. 2A through 3B) and rotating for three-hundred and sixty degrees around the race 111 (See FIGS. 2A through 3B).

Still referring to FIGS. 4A, 4C, 4D, and 4E, the fastening means 202 is preferably positioned at a point on the outside diameter of the annulus 201. In the preferable embodiment, the fastening means 202 is a loop 203 for receiving a clip 4 (see FIG. 1; see also e.g., U.S. Pat. No. 940,738 (issued Nov. 23, 1909)). However, the fastening means 202 may be any variety of component capable of affixing or fastening an object to the ring, including but not limited to, for example: a screw/nut system; a snap system; a clip; hook and loop; weld joint; adhesive; hook; and the like.

Still referring to FIGS. 4A, 4C, 4D, and 4E, a first preferable embodiment of the ring 200 for assembly with the first preferable embodiment of the collar 100 disclosed above may suitably be dimensioned as follows: the inside diameter of the annulus 201 is preferably 1.200 inches; the outside diameter of the annulus 201 is between about 1.660 inches and about 1.440 inches; the height is suitably 0.14 inch; the loop 203 features an inner diameter of 0.33 inch and an outer diameter of 0.57 inch; and the distance between the center of the loop 203 and the center of the annulus 201 may be 1.130 inches. In a second preferable embodiment of the ring 200 for assembly with the second preferable embodiment of the collar 100 disclosed above, the ring 200 may alternatively be dimensioned as follows: the inside diameter of the annulus 201 is preferably 1.260 inches; the outside diameter of the annulus 201 is between about 1.730 inches and about 1.480 inches; the height is suitably 0.14 inch; the loop 203 features an inner diameter of 0.33 inch and an outer diameter of 0.57 inch; and the distance between the center of the loop 203 and the center of the annulus 201 may be 1.165 inches. In yet a third preferable embodiment of the ring 200 for use with the third preferable embodiment of the collar 100 disclosed above, the ring 200 may alternatively be dimensioned as follows: the inside diameter of the annulus 201 is preferably 1.450 inches; the outside diameter of the annulus 201 is between about 1.940 inches and about 1.670 inches; the height is suitably 0.14 inch; the loop 203 features an inner diameter of 0.33 inch and an outer diameter of 0.57 inch; and the distance between the center of the loop 203 and the center of the annulus 201 may be 1.315 inches. Preferably, edges on the ring 100 may be rounded at a 0.05 inch radius of curvature. Suitably, dimension tolerances are: ±0.050 for dimensions identified with one significant digit on the fraction side of the decimal; ±0.010 for dimensions identified with two significant digits on the fraction side of the decimal; and, ±0.005 for dimensions identified with three significant digits on the fraction side of the decimal.

Unlike the collar 100, the ring 200 should preferably not undergo structural deformation. Accordingly, the ring 200 should preferably be composed of materials featuring the properties and strength sufficient to retain its shape and secure an object to the collar 100 despite substantial torquing or axial forces. Such materials will be readily known to one of skill in the art, and may include, without being limited to: plastics (e.g., Nylon); polymers, PVC, polypropylene, polyethylene; formed metals; woods; ceramics; composites and other synthetic or natural materials whether molded, extruded, stamped or otherwise fabricated.

FIG. 4A through 4C disclose a preferable method of assembling the apparatus 1 comprising a unitary collar 100 and ring 200. First, a scissoring force is applied across the deflection accommodator 103 slot whereby the collar structure deforms into a helical configuration with the smaller outer diametered portion of the upper wall 112 deflected backward relative to the top surface 101. Second, referring to FIG. 4B, the larger outer diametered portion the upper surface 101 of the collar 100, at the deflection accommodator 103 slot, is directed toward the inside of the annulus 201 whereby a portion of the annulus 201 is seated within a portion of the annular grove 210. As seen in FIG. 4B, the collar's 200 helical structure preferably has a portion within the plane of the ring 200 and a portion offset from the plane of the ring 200. Third, a force is applied to the collar 100 to reduce the width of the deflection accommodator 103 slot whereby the helical structure of the collar 100 compresses. Fourth, the helical structure of the collar is levered toward the center of the annulus 201, the fulcrum preferably being the portion of the annulus 201 seated in the groove 210. The compression of the collar 100 and the associated reduction of the spiraling outer plan of the upper wall 112 allow the top side 101 of the collar 100 to pass through the center of the annulus 201 whereafter the resilient properties of the collar 100 operate to reconfigure the normal structure of collar 100 with the ring 200 annularly seated therein.

FIG. 4A through 4C further disclose another preferable method of assembling the apparatus 1 comprising a unitary collar 100 and ring 200. As before, the collar is first deformed to a helical configuration and the larger outer diametered portion of the upper surface 101 is directed toward the inside of the annulus 201 whereby a portion of the annulus 201 is seated within a portion of the annular grove 210 as depicted in FIG. 4B. Next, the collar 100 is suitably rotated relative to the ring 200 along its helical structure within the annulus 201 wherein the upper wall 112 of the groove 110 and the annulus 201 interact in the manner of cooperating screw and nut threads. In other words, as the collar 100 turns relative to the ring 200, the remaining portion of the collar 100 moves to within the annulus 201 whereby the ring 200 is annularly seated within the groove 110 of a normally configured collar 100.

Suitably, the collar may be unseated by: compressing the deflection accommodator 103 slot; pressing the top surface 101 of the collar 100 at its most reduced outer diameter through the annulus 201 whereby a portion of the collar is out of plane with the ring 200; and levering or rotating the ring to without the annulus 201 in an opposite manner than disclosed for assembly.

Given the above disclosure of structural features and assembly methods, the presently disclosed apparatus 1 represents a significant advancement over the present state of the art. Below are listed a few, non limiting, examples of the advancement. First, the present disclosure, unlike typical structures for swivelably securing an object to a pole, contemplates that both the ring 200 and collar 100 may be cast as unitary components whereby manufacturing costs and times are reduced. For example, the ability to lever the collar 100 to within the annulus 201 of the ring 200, as disclosed above, is much easier than building the ring 200 around the collar 100 or vice versa, as disclosed in the current state of the art. Furthermore, unlike the apparatus which are composed of rings and collars comprising many or broken pieces, the unitary nature of the components increases the structural integrity and strength of the apparatus 1 during swiveling operation. Although structures are known wherein unitary collars and unitary rings are assembled (e.g., U.S. Pat. No. 5,375,555), the present disclosure allows for a greater differential in the outer diameter or plan of the groove 110 walls and the annulus of the ring 200 whereby greater swivel guidance is provided and apparatus malfunction is minimized. The apparatus provides an improvement to assembly according to pipe-coupling methods since the collar 100 and ring 200 may be: readily and easily assembled and disassembled; fabricated unitarily with a minimal amount of materials; and, constructed without bulky disassembly mechanisms. In addition, the structural features and assembly methods disclosed, unlike any of the prior art, allow construction of a collar 100 with a deeper annular groove 110 for more predictable and reliable retention of the ring 200 while swivelably securing an object to a pole.

It should be noted that FIGS. 1 through 4E and the associated description are of illustrative importance only. In other words, the depiction and descriptions of the present invention should not be construed as limiting of the subject matter in this application. Additional modifications may become apparent to one skilled in the art after reading this disclosure.

I claim:

1. A swivel clip comprising:
a collar with a spiraling rim and a slot therethrough;
a ring operational configured to fit within a groove disposed on an outward facing surface of the collar; and,
a fastening means on said ring.

2. A swivel apparatus comprising:
an annular groove, the groove featuring a side wall having a spiraling plan; and,
a rotator with an annulus featuring a center that is smaller than the side wall, the rotator configured to sit within the groove for guided movement therein.

3. The apparatus of claim 2 wherein the groove encircles a pole.

4. The apparatus of claim 2 wherein the groove is defined on a unitary collar wherein the collar further features a deflection accommodator.

5. The apparatus of claim 4 wherein the effective perimeter of the spiraling plan is varied via manipulating the deflection accommodator.

6. The apparatus of claim 4 wherein the collar is configured to structurally deform into a helical configuration via manipulating the deflection accommodator.

7. The apparatus of claim 4 wherein the perimeter of the spiraling plan is reduced and deformation of the collar into a helical configuration is accomplished via manipulating the deflection accommodator.

8. The apparatus of claim 4 wherein the deflection accommodator is a slot in the collar.

9. A method of seating an annulus in a groove with a spirally planned rim of greater plan than the center of the annulus, the method comprising the steps of:
seating a portion of the annulus within a portion of the groove to create a fulcrum;
reducing the perimeter of the spirally planned rim;
levering the ring toward the groove whereby the spirally planned rim passes through the center of the annulus; and,
increasing the perimeter of the spirally planned rim.

10. The method of claim 9 wherein the groove encircles a pole.

11. The method of claim 9 wherein the perimeter of the spiraling planned rim is reduced via manipulating a deflection accommodator provided to the groove.

12. The method of claim 9 further comprising the step of manipulating the groove's structure into a helical configuration before the step of seating a portion of the annulus within said portion of the groove.

13. The method of claim 9 wherein the deflection accommodator is a slot in the groove.

14. The method of claim 9 wherein the groove is on a collar and the annulus is a rotator whereby the collar and rotator may be assembled into an apparatus for swivelably securing an object to a pole.

15. A method of seating an annulus in a groove with a spirally planned rim of greater plan than the center of the annulus, the method comprising the steps of:
seating a portion of the annulus within a portion of the groove to create a fulcrum; and,
rotating the annulus with respect to the groove whereby the annulus and the spirally planned rim threadedly cooperate to move spirally planned rim through the center of the annulus.

16. The method of claim 14 wherein the groove encircles a pole.

17. The method of claim 9 further comprising the step of manipulating the groove's structure into a helical configuration before the step of seating a portion of the annulus within said portion of the groove.

18. The method of claim 17 wherein the helical configuration groove returns to its original configuration after the step of rotating the annulus with respect to the groove.

19. The method of claim 17 wherein the structural deformation of the groove is accomplished via a deflection accommodator.

20. The method of claim 14 wherein the groove is on a collar and the annulus is a rotator whereby the collar and rotator may be assembled into an apparatus for swivelably securing an object to a pole.

21. A swivel clip comprising:
a unitary collar having, a top side, a bottom side, a deflection accommodator slot, a pole receptacle, and an annular groove encircling the pole receptacle;
wherein, the groove is defined by a spiraling upper rim and a lower rim; and,
a ring configured to annularly seat in the groove between the upper and lower rims.

22. A method of hanging a flag on a pole comprising the steps of:
obtaining a collar with an annular groove, the groove featuring a side wall having a spiraling plan;
obtaining a rotator with an annulus featuring a center that is smaller than the spiraling plan, the rotator configured to sit within the groove for guided movement therein;
seating the rotator within the groove whereby the collar and rotator become an assembled apparatus;
locating the apparatus on the pole; and,
securing a flag to the rotator.
